(19) United States
(12) Patent Application Publication
(10) Pub. No.: US 2016/0203549 A1
(43) Pub. Date: Jul. 14, 2016

(54) METHOD AND SYSTEM FOR ACCOUNTS RECEIVABLE OPTIMIZATION

(71) Applicant: MASTERCARD INTERNATIONAL INCORPORATED, Purchase, NY (US)

(72) Inventors: Robert Snyder, Monsey, NJ (US); Edward Downs, River Vale, NJ (US)

(21) Appl. No.: 14/592,369

(22) Filed: Jan. 8, 2015

(51) Int. Cl. G06Q 40/00; G06Q 30/02

(52) U.S. Cl. CPC G06Q 40/00; G06Q 30/0222

(57) ABSTRACT

A method that includes providing at least one account; calculating a receivable management optimization score for the at least one account based on at least one financial parameter; determining one or more receivable management optimization strategies for the at least one account based on the calculated receivable management optimization score; and applying the one or more receivable management optimization strategies to the at least one account. A system that includes one or more databases including at least one account; and a processor configured to: calculate a receivable management optimization score for the at least one account based on at least one financial parameter; determine one or more receivable management optimization strategies for the at least one account based on the calculated receivable management optimization score; and apply the one or more receivable management optimization strategies to the at least one account.

### BACKGROUND OF THE DISCLOSURE

1. Field of the Disclosure

The present disclosure relates to a method and a system for accounts receivable optimization. In particular, this disclosure relates to applying a receivable management optimization strategy to a merchant account based on a calculated receivable management optimization score. The receivable management optimization score is calculated by a merchant cost benefit model based on acceptance by the merchant of a commercial payment card.

2. Description of the Related Art

Businesses regularly use online services to conduct various aspects of their work. As such, doing business ‘ online’ is a preferred channel of an increasingly significant portion of businesses today. While checking accounts are often the “anchor” products that establish a business banking relationship with a business, businesses (e.g., small businesses) are increasingly willing to complete transactions online. Such transactions range from paying bills to invoicing. Only a small percentage of businesses manage their cash through their bank's business banking/cash management solutions. Although an increasingly significant percentage of businesses pay some of their bills online, few do so at their bank's website.

Sometimes payment volume growth within a payment processing system, such as growth in the United States of credit and debit cards (i.e., MasterCard, Visa, etc.) for payments, is limited by businesses not accepting payment by payers that wish to use their credit and debit cards to pay. One reason that the businesses may not accept such payments by the payers is the cost of terminalization, i.e., installing and maintaining a machine to accept payments from credit and/or debit accounts. Terminalization is particularly costly for payees that are small and/or are infrequent recipients of payments upon such accounts of payers. Moreover, some banks are reluctant to process payments from credit and debit accounts for small businesses. Further, businesses tied to payments by cash and checks generally lack tools necessary to enable efficient accounts receivables in a fast and low cost manner.

The accounts receivables management industry deals with the collection of unpaid debt in all sectors of the economy (e.g., health care, student loans, credit cards, and retail). While some entities may try to collect their own unpaid debts, typically the delinquent accounts are turned over to a third party debt collector to manage the process of collecting the unpaid amounts. Such debt collectors employ various strategies to collect on unpaid accounts, such as making multiple phone calls to the debtor and sending a series of letters to the debtor's house. While implementation of one strategy for all debtors may be simple, it has been found that different and more tailored strategies for different types of debts are more effective and maximize returns on collection efforts. Unfortunately, such tailored strategies are costly and difficult to implement and manage.

Accordingly, there exists a need for a way to effectively implement, manage, monitor, and improve accounts receivable strategies, in particular, accounts receivable strategies that can afford cost savings to businesses and other advantages as well.

### SUMMARY OF THE DISCLOSURE

The present disclosure relates to a method and a system for accounts receivable optimization. In particular, this disclosure relates to applying a receivable management optimization strategy to a merchant account based on a calculated receivable management optimization score. The receivable management optimization score is calculated by a merchant cost benefit model based on acceptance by the merchant of a commercial payment card.

The present disclosure also provides a method that comprises: providing at least one account; calculating, by a processor, a receivable management optimization score for the at least one account based on at least one financial parameter; determining, by the processor, one or more receivable management optimization strategies for the at least one account based on the calculated receivable management optimization score; and applying, by the processor, the one or more receivable management optimization strategies to the at least one account.

In accordance with this disclosure, the receivable management optimization score is calculated by a merchant cost benefit model based on acceptance by the merchant of a commercial payment card. The merchant cost benefit model comprises the steps of: (i) providing general merchant information including a percentage of account receivables with early pay discount; (ii) calculating savings in currency based on avoidance of cost for the early pay discount; (iii) calculating savings in currency based on avoidance of cost of funds for days sales outstanding (DSO); (iv) calculating savings in currency based on avoidance of handling and funds transfer cost for account receivables; (v) calculating savings in currency based on avoidance of bad debt cost for account receivables; (vi) determining cost in currency for merchant discount fee or the fee charged to the merchant by a bank for providing the commercial payment card; and (vii) calculating the receivable management optimization score in currency by subtracting the cost in (vi) from the total savings in (ii)-(v).

The present disclosure further provides a system that comprises: one or more databases including at least one account, each account comprising account information; and a processor configured to: calculate a receivable management optimization score for the at least one account based on at least one financial parameter; determine one or more receivable management optimization strategies for the at least one account based on the calculated receivable management optimization score; and apply the one or more receivable management optimization strategies to the at least one account.

The advantages afforded by the method and system for accounts receivables optimization of this disclosure is based on commercial payment card acceptance by a merchant. Through commercial payment card acceptance by a merchant, a way is provided to effectively implement, manage, monitor, and improve accounts receivables strategies, in particular, accounts receivables strategies that can afford cost savings to businesses and other advantages as well.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain merchant information and accounts receivables data and information.

FIG. 3 illustrates a merchant cost benefit model calculator for calculating the receivable management optimization score based on acceptance by a merchant of a commercial payment card.

FIG. 4 depicts account receivables optimization factors for business entities involving large suppliers and large buyers.

FIG. 5 depicts account receivables optimization factors for business entities involving large suppliers and small buyers.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the disclosure are shown. Indeed, the disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, the one or more databases configured to store the at least one account information can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage device, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to enable accounts receivable optimization by merchants that is based on commercial payment card acceptance by a merchant. Through commercial payment card acceptance by a merchant, a way is provided to effectively implement, manage, monitor, and improve accounts receivable strategies, in particular, accounts receivable strategies that can afford cost savings to businesses and other advantages as well.

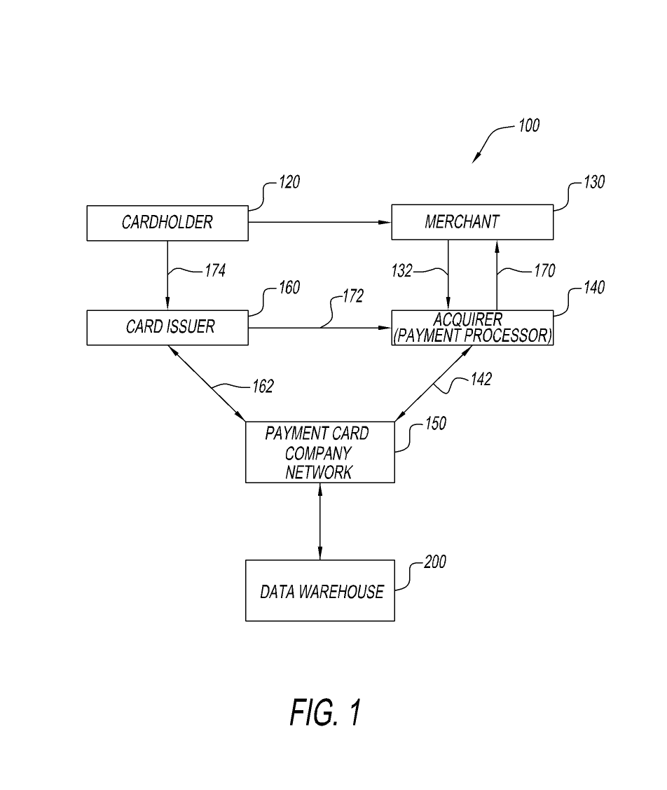

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

Data warehouse 200 is a database used by payment card company network 150 for reporting and data analysis. According to one embodiment, data warehouse 200 is a central repository of data that is created by storing certain transaction data from transactions occurring within four party payment card system 100. According to another embodiment, data warehouse 200 stores, for example, the date, time, amount, location, merchant code, and merchant category for every transaction occurring within payment card network 150.

According to another embodiment, data warehouse 200 stores, reviews and analyzes, for example, merchant information and merchant accounts receivables information. In particular, data warehouse 200 stores information and data relating to the merchant cost benefit model, and for calculating the receivable management optimization score. The information and data for the merchant cost benefit model includes general merchant information including a percentage of account receivables with early pay discount; information and data for calculating savings in currency based on avoidance of cost for the early pay discount; information and data for calculating savings in currency based on avoidance of cost of funds for days sales outstanding (DSO); information and data for calculating savings in currency based on avoidance of handling and funds transfer cost for account receivables; information and data for calculating savings in currency based on avoidance of bad debt cost for account receivables; information and data for determining cost in currency for merchant discount fee or the fee charged to the merchant by a bank for providing the commercial payment card; and information and data for calculating the receivable management optimization score in currency by subtracting the cost in (vi) from the total savings in (ii)-(v).

In an embodiment, data warehouse 200 stores, reviews, and/or analyzes general merchant information including merchant industry or categorization, target annual receivables with a payment card company, target annual transactions with a payment card company, average transaction size, and a percentage of account receivables with early pay discount.

In another embodiment, data warehouse 200 stores, reviews, and/or analyzes information for calculating savings in currency based on avoidance of cost for the early pay discount. The calculating is based on total receivables electing to pay early, early pay discount, and days outstanding.

In yet another embodiment, data warehouse 200 stores, reviews, and/or analyzes information for calculating savings in currency based on avoidance of cost of funds for days sales outstanding. The calculating is based on current average days sales outstanding, payment term with payment card, speed of pay benefit, and merchant cost of funds.

In still another embodiment, data warehouse 200 stores, reviews, and/or analyzes information for calculating savings in currency based on avoidance of handling and funds transfer cost for account receivables. The calculating is based on invoicing savings per transaction, funds transfer savings per transaction, and total annual transactions with a payment card company.

In another embodiment, data warehouse 200 stores, reviews, and/or analyzes information for calculating savings in currency based on avoidance of bad debt cost for account receivables. The calculating is based on bad debt ratio as a percent of account receivables, and total volume of annual receivables with payment card company.

In another embodiment, data warehouse 200 stores, reviews, and/or analyzes information for determining cost in currency for merchant discount fee or the fee charged to the merchant by a bank for providing the commercial payment card.

In yet another embodiment, data warehouse 200 stores, reviews, and/or analyzes information for calculating the receivable management optimization score in currency by subtracting the costs from the total savings as described herein.

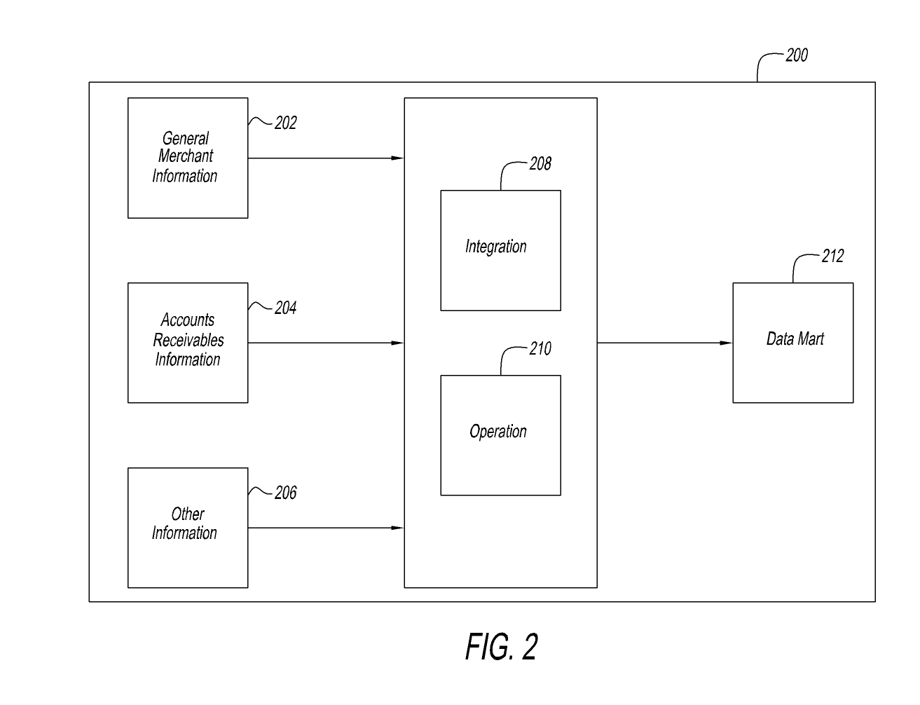

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

The general merchant information 202 can include, for example, merchant industry or categorization, target annual receivables with a payment card company, target annual transactions with a payment card company, average transaction size, and a percentage of account receivables with early pay discount.

A merchant category can include a segment of a particular industry. In some embodiments, the merchant category can be defined using merchant category codes according to predefined industries, which can be aligned using standard industrial classification codes, or using the industry categorization described herein.

Merchant categorization indicates the category or categories assigned to each merchant name. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable |
| | Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

The merchant accounts receivable information 204 can include, for example, information for calculating savings in currency based on avoidance of cost for the early pay discount. The calculating is based on total receivables electing to pay early, early pay discount, and days outstanding. The merchant accounts receivable information 204 can also include, for example, information for calculating savings in currency based on avoidance of cost of funds for days sales outstanding. The calculating is based on current average days sales outstanding, payment term with payment card, speed of pay benefit, and merchant cost of funds.

The merchant accounts receivable information 204 can further include, for example, information for calculating savings in currency based on avoidance of handling and funds transfer cost for account receivables. The calculating is based on invoicing savings per transaction, funds transfer savings per transaction, and total annual transactions with a payment card company. The merchant accounts receivable information 204 can yet further include, for example, information for calculating savings in currency based on avoidance of bad debt cost for account receivables. The calculating is based on bad debt ratio as a percent of account receivables, and total volume of annual receivables with payment card company.

The merchant accounts receivable information 204 can also include, for example, information for determining cost in currency for merchant discount fee or the fee charged to the merchant by a bank for providing the commercial payment card. The merchant accounts receivable information 204 can further include, for example, information for calculating the receivable management optimization score in currency by subtracting the costs from the total savings as described herein.

The other information 206 includes, for example, geographic data and demographic data. The other information 206 can include other suitable information that can be useful in a method and a system for accounts receivable optimization, and applying a receivable management optimization strategy to a merchant account based on a calculated receivable management optimization score.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operation data store database 210. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source systems does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. Data warehouses can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the way or means to retrieve and analyze data, to extract, transform and load data, and to manage the data dictionary are also considered essential components of a data warehousing system. Many references to data warehousing use this broader context. Thus, an expanded definition for data warehousing includes business intelligence tools, tools to extract, transform and load data into the repository, and tools to manage and retrieve metadata.

Algorithms can be employed to determine formulaic descriptions of the integration of the data source information using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

In particular, these formulas can be used for calculating savings in currency based on avoidance of cost for the early pay discount; calculating savings in currency based on avoidance of cost of funds for days sales outstanding (DSO); calculating savings in currency based on avoidance of handling and funds transfer cost for account receivables; calculating savings in currency based on avoidance of bad debt cost for account receivables; and calculating the receivable management optimization score in currency by subtracting the cost from the total savings as described herein.

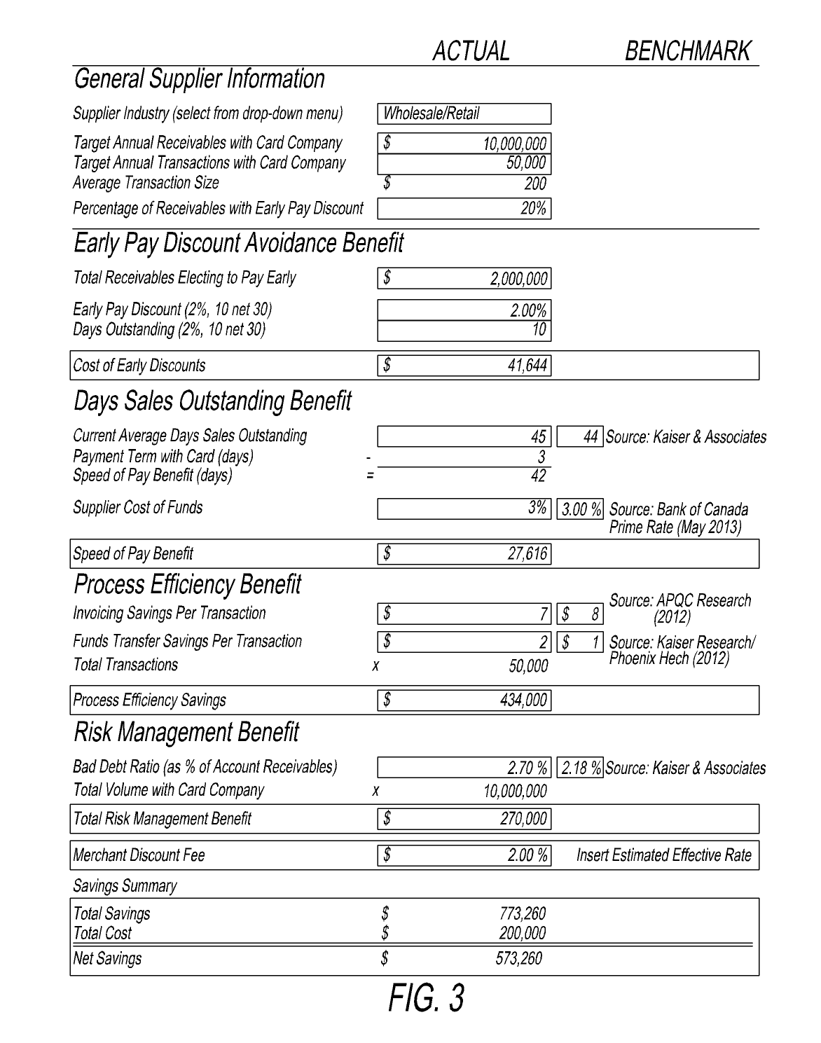

FIG. 3 illustrates a merchant cost benefit model for calculating the receivable management optimization score based on acceptance by a merchant of a commercial payment card. The merchant cost benefit model consists of general merchant information, early pay discount avoidance benefit, days sales outstanding benefit, process efficiency benefit, and risk management benefit. The savings for a merchant or receivables management optimization score, based on acceptance by the merchant of a commercial payment card, is calculated from the merchant cost benefit model.

Referring to FIG. 3, the receivable management optimization score is calculated by a merchant cost benefit model based on acceptance by the merchant of a commercial payment card. The merchant cost benefit model comprising the steps of (i) providing general merchant information including a percentage of account receivables with early pay discount; (ii) calculating savings in currency based on avoidance of cost for the early pay discount; (iii) calculating savings in currency based on avoidance of cost of funds for days sales outstanding (DSO); (iv) calculating savings in currency based on avoidance of handling and funds transfer cost for account receivables; (v) calculating savings in currency based on avoidance of bad debt cost for account receivables; (vi) determining cost in currency for merchant discount fee or the fee charged to the merchant by a bank for providing the commercial payment card; and (vii) calculating the receivable management optimization score in currency by subtracting the cost in (vi) from the total savings in (ii)-(v).

The general merchant information can include, for example, merchant industry or categorization, target annual receivables with a payment card company, target annual transactions with a payment card company, average transaction size, and a percentage of account receivables with early pay discount.

For calculating savings in currency based on avoidance of cost for the early pay discount, the calculating is based on total receivables electing to pay early, early pay discount, and days outstanding.

For calculating savings in currency based on avoidance of cost of funds for days sales outstanding, the calculating is based on current average days sales outstanding, payment term with payment card, speed of pay benefit, and merchant cost of funds.

For calculating savings in currency based on avoidance of handling and funds transfer cost for account receivables, the calculating is based on invoicing savings per transaction, funds transfer savings per transaction, and total annual transactions with a payment card company.

For calculating savings in currency based on avoidance of bad debt cost for account receivables, the calculating is based on bad debt ratio as a percent of account receivables, and total volume of annual receivables with payment card company.

The merchant cost benefit model can also include, for example, information for determining cost in currency for merchant discount fee or the fee charged to the merchant by a bank for providing the commercial payment card. The merchant cost benefit model can further include, for example, information for calculating the receivable management optimization score in currency by subtracting the costs from the total savings as described herein.

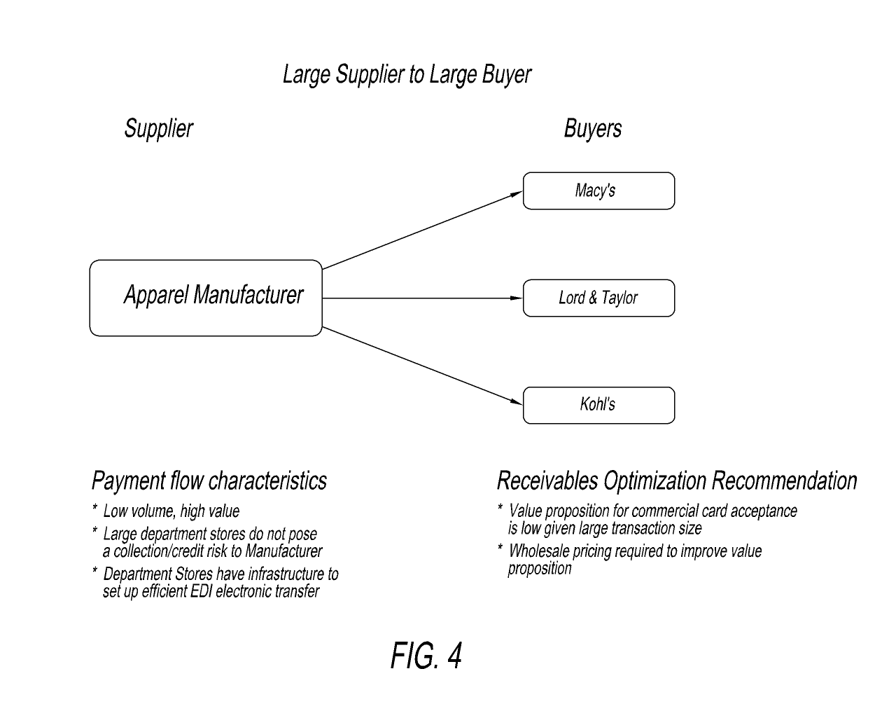

FIG. 4 depicts account receivables optimization factors for business entities involving large suppliers and large buyers.

In this situation, the payments from Buyers to Sellers are generally of low volume and high value. Large department stores do not pose a collection/credit risk to a manufacturer. Moreover, large department stores have the infrastructure to set up efficient electronic data interchange (EDI) electronic funds transfer.

From a receivables optimization perspective, the value proposition for commercial card acceptance is likely to be low given the large transaction size. Wholesale pricing is likely required to improve value proposition.

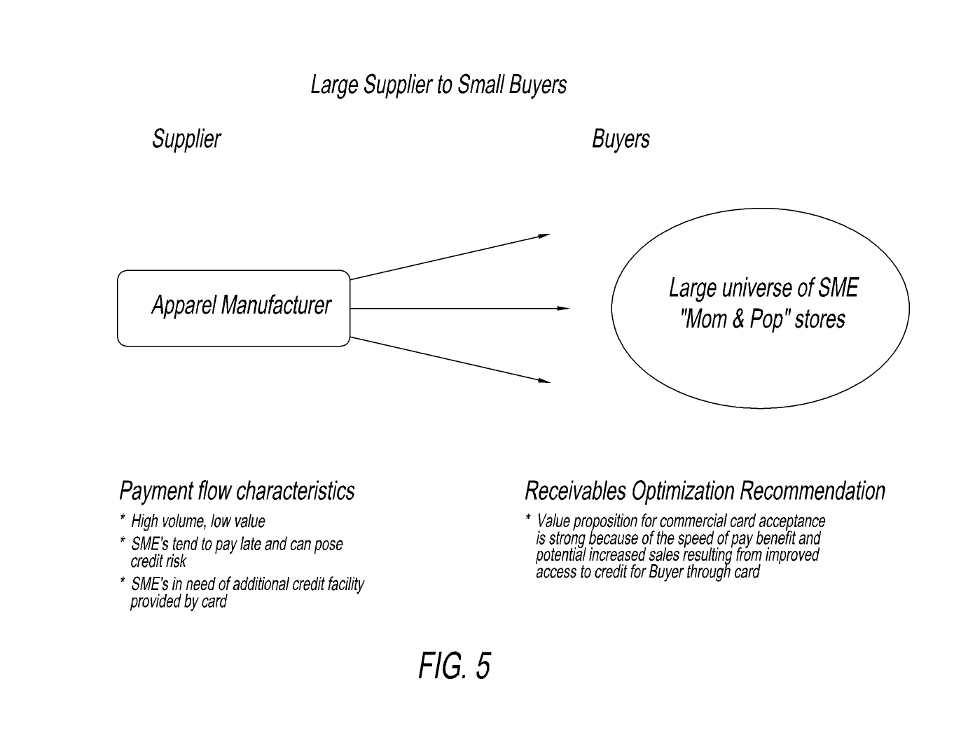

FIG. 5 depicts account receivables optimization factors for business entities involving large suppliers and small buyers (i.e., a large universe of small or medium sized enterprises (SME) such as Mom & Pop stores).

In this situation, the payments from Buyers to Sellers are generally of a high volume and low value. Unlike large department stores, SMEs tend to pay late and can pose a credit risk. Moreover, the SMEs likely are in need of an additional credit facility provided by a commercial payment card.

From a receivables optimization perspective, the value proposition for commercial card acceptance is strong because of the speed of payment benefit and potential increased sales resulting from improved access to credit for buyers through a commercial payment card.

It will be understood that the present disclosure can be embodied in a computer readable non-transitory storage medium storing instructions of a computer program which when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
providing at least one account;
calculating, by a processor, a receivable management optimization score for the at least one account based on at least one associated financial parameter;
determining, by the processor, one or more receivable management optimization strategies for the at least one account based on the calculated receivable management optimization score; and
applying, by the processor, the one or more receivable management optimization strategies to the at least one account.

2. The method of claim 1, wherein the receivable management optimization score is calculated by a merchant cost benefit model based on acceptance by the merchant of a commercial payment card, said merchant cost benefit model comprising the steps of:
(i) providing general merchant information including a percentage of account receivables with early pay discount;
(ii) calculating savings in currency based on avoidance of cost for the early pay discount;
(iii) calculating savings in currency based on avoidance of cost of funds for days sales outstanding (DSO);
(iv) calculating savings in currency based on avoidance of handling and funds transfer cost for account receivables;
(v) calculating savings in currency based on avoidance of bad debt cost for account receivables;
(vi) determining cost in currency for merchant discount fee or the fee charged to the merchant by a bank for providing the commercial payment card; and
(vii) calculating the receivable management optimization score in currency by subtracting the cost in (vi) from the total savings in (ii)-(v).

3. The method of claim 1, wherein the at least one account comprises a large market merchant, wherein the large market merchant has a supply arrangement with at least one of a mid-market merchant and a small market merchant, and wherein at least one of the mid-market merchant and the small market merchant have accepted a commercial payment card used to make purchases from the large market merchant.

4. The method of claim 1, wherein the at least one account comprises at least one of a mid-market merchant and a small market merchant, wherein at least one of the mid-market merchant and the small market merchant has a supply arrangement with a large market merchant, and wherein the large market merchant has accepted a commercial payment card used to make purchases from at least one of the mid-market merchant and the small market merchant.

5. The method of claim 1, wherein the at least one account comprises a large market merchant, wherein the large market merchant has a buyer arrangement with at least one of a mid-market merchant and a small market merchant, wherein at least one of the mid-market merchant and the small market merchant has accepted a commercial payment card, and wherein the large market merchant uses a commercial payment card to make purchases from at least one of the mid-market merchant and the small market merchant.

6. The method of claim 1, wherein the at least one account comprises at least one of a first mid-market merchant and a first small market merchant, wherein at least one of the first mid-market merchant and the first small market merchant has a supply arrangement with at least one of a second mid-market merchant and a second small market merchant, and wherein at least one of the second mid-market merchant and the second small market merchant have accepted a commercial payment card used to make purchases from at least one of the first mid-market merchant and the first small market merchant.

7. The method of claim 1, wherein the at least one account comprises at least one of a second mid-market merchant and a second small market merchant, wherein at least one of the second mid-market merchant and the second small market merchant has a supply arrangement with at least one of a first mid-market merchant and a first small market merchant, and wherein at least one of the first mid-market merchant and the first small market merchant has accepted a commercial payment card used to make purchases from at least one of the second mid-market merchant and the second small market merchant.

8. The method of claim 1, wherein the at least one account comprises at least one of a first mid-market merchant and a first small market merchant, wherein at least one of the first mid-market merchant and the first small market merchant has a buyer arrangement with at least one of a second mid-market merchant and a second small market merchant, wherein at least one of the second mid-market merchant and the second small market merchant has accepted a commercial payment card, and wherein at least one of the first mid-market merchant and the first small market merchant uses a commercial payment card to make purchases from at least one of the second mid-market merchant and the second small market merchant.

9. The method of claim 2, wherein step (i) comprises providing general merchant information including merchant industry or categorization, target annual receivables with a payment card company, target annual transactions with a payment card company, average transaction size, and a percentage of account receivables with early pay discount.

10. The method of claim 2, wherein step (ii) comprises calculating savings in currency based on avoidance of cost for the early pay discount, and wherein the calculating savings is based on total receivables electing to pay early, early pay discount, and days outstanding.

11. The method of claim 2, wherein step (iii) comprises calculating savings in currency based on avoidance of cost of funds for days sales outstanding, and wherein the calculating savings is based on current average days sales outstanding, payment term with payment card, speed of pay benefit, and merchant cost of funds.

12. The method of claim 2, wherein step (iv) comprises calculating savings in currency based on avoidance of handling and funds transfer cost for account receivables, and wherein the calculating savings is based on invoicing savings per transaction, funds transfer savings per transaction, and total annual transactions with a payment card company.

13. The method of claim 2, wherein step (v) comprises calculating savings in currency based on avoidance of bad debt cost for account receivables, and wherein the calculating savings is based on bad debt ratio as a percent of account receivables, and total volume of annual receivables with payment card company.

14. The method of claim 2, wherein the receivable management optimization score is algorithmically calculated by the merchant cost benefit model based on acceptance by the merchant of a commercial payment card.

15. A system comprising:
one or more databases including at least one account, each account comprising account information; and
a processor configured to:
calculate a receivable management optimization score for the at least one account based on at least one financial parameter;
determine one or more receivable management optimization strategies for the at least one account based on the calculated receivable management optimization score; and
apply the one or more receivable management optimization strategies to the at least one account.

16. The system of claim 15, wherein the processor is configured to calculate the receivable management optimization score utilizing a merchant cost benefit model based on acceptance by the merchant of a commercial payment card.

17. The system of claim 16, wherein the processor is configured to:
(i) provide general merchant information including a percentage of account receivables with early pay discount;
(ii) calculate savings in currency based on avoidance of cost for the early pay discount;
(iii) calculate savings in currency based on avoidance of cost of funds for days sales outstanding (DSO);
(iv) calculate savings in currency based on avoidance of handling and funds transfer cost for account receivables;
(v) calculate savings in currency based on avoidance of bad debt cost for account receivables;
(vi) determine cost in currency for merchant discount fee or the fee charged to the merchant by a bank for providing the commercial payment card; and
(vii) calculate the receivable management optimization score in currency by subtracting the cost in (vi) from the total savings in (ii)-(v).

18. The system of claim 15, wherein the at least one account comprises a market merchant selected from the group consisting of: (a) a large market merchant, wherein the large market merchant has a supply arrangement with at least one of a mid-market merchant and a small market merchant, and wherein at least one of the mid-market merchant and the small market merchant have accepted a commercial payment card used to make purchases from the large market merchant; (b) at least one of a mid-market merchant and a small market merchant, wherein at least one of the mid-market merchant and the small market merchant has a supply arrangement with a large market merchant, and wherein the large market merchant has accepted a commercial payment card used to make purchases from at least one of the mid-market merchant and the small market merchant; (c) a large market merchant, wherein the large market merchant has a buyer arrangement with at least one of a mid-market merchant and a small market merchant, wherein at least one of the mid-market merchant and the small market merchant has accepted a commercial payment card, and wherein the large market merchant uses a commercial payment card to make purchases from at least one of the mid-market merchant and the small market merchant; (d) at least one of a first mid-market merchant and a first small market merchant, wherein at least one of the first mid-market merchant and the first small market merchant has a supply arrangement with at least one of a second mid-market merchant and a second small market merchant, and wherein at least one of the second mid-market merchant and the second small market merchant have accepted a commercial payment card used to make purchases from at least one of the first mid-market merchant and the first small market merchant; (e) at least one of a second mid-market merchant and a second small market merchant, wherein at least one of the second mid-market merchant and the second small market merchant has a supply arrangement with at least one of a first mid-market merchant and a first small market merchant, and wherein at least one of the first mid-market merchant and the first small market merchant has accepted a commercial payment card used to make purchases from at least one of the second mid-market merchant and the second small market merchant; and (f) at least one of a first mid-market merchant and a first small market merchant, wherein at least one of the first mid-market merchant and the first small market merchant has a buyer arrangement with at least one of a second mid-market merchant and a second small market merchant, wherein at least one of the second mid-market merchant and the second small market merchant has accepted a commercial payment card, and wherein at least one of the first mid-market merchant and the first small market merchant uses a commercial payment card to make purchases from at least one of the second mid-market merchant and the second small market merchant.

19. The system of claim 17, wherein the processor is configured to perform a function selected from the group consisting of: (a) provide in step (i) general merchant information including merchant industry or categorization, target annual receivables with a payment card company, target annual transactions with a payment card company, average transaction size, and a percentage of account receivables with early pay discount; (b) calculate in step (ii) savings in currency based on avoidance of cost for the early pay discount; wherein the calculating is based on total receivables electing to pay early, early pay discount, and days outstanding; (c) calculate in step (iii) savings in currency based on avoidance of cost of funds for days sales outstanding; wherein the calculating is based on current average days sales outstanding, payment term with payment card, speed of pay benefit, and merchant cost of funds; (d) calculate in step (iv) savings in currency based on avoidance of handling and funds transfer cost for account receivables; wherein the calculating is based on invoicing savings per transaction, funds transfer savings per transaction, and total annual transactions with a payment card company; and (e) calculate in step (v) savings in currency based on avoidance of bad debt cost for account receivables; wherein the calculating is based on bad debt ratio as a percent of account receivables, and total volume of annual receivables with payment card company.

20. The system of claim 15, wherein the processor is configured to algorithmically calculate the receivable management optimization score utilizing a merchant cost benefit model based on acceptance by the merchant of a commercial payment card.
